(19) United States
(12) Patent Application Publication
(10) Pub. No.: US 2006/0039138 A1
(43) Pub. Date: Feb. 23, 2006

(54) Balloon illuminator

(76) Inventor: Douglas Grant Oxborrow, Pasadena, TX (US)

Correspondence Address: Douglas Grant Oxborrow, 4311 Valparaiso, Pasadena, TX, 77504, US

(21) Appl. No.: 11/209,256

(22) Filed: Aug. 23, 2005

Related U.S. Application Data
(60) Provisional application No. 60/603,649, filed on Aug. 23, 2004.

(51) Int. Cl. F21L 4/00

(52) U.S. Cl. 362/189; 362/253; 362/96

(57) ABSTRACT

A balloon illuminator that can emit either a flashing or constant light depending on the polarity of the battery used to power the device. The device can be modified to cycle through a series of colors. The balloon illuminator is comprised of a lens, light emitting diode, a battery, and means to switch the balloon illuminator from flashing to constant light mode depending on the polarity of the battery and a housing lined with electricity conducting material. Once fully assembled, with each component contained in the housing, the electrical circuit formed by housing and components is closed and the balloon illuminator emits light. The balloon illuminator also works without a lens, though in the preferred embodiment, the lens is used to disperse the light more fully in the interior of the balloon. A balloon illuminator that uses a multi color light emitting diode can cycle through a series of colors once the illuminator is fully assembled and the electrical circuit completed. The balloon illuminator is impervious to liquid and is compatible with liquid sealants used to coat the inner lining of latex balloons to prevent leakage of gas.

### REFERENCE TO RELATED PROVISIONAL APPLICATIONS

This application claims the benefit of the filing date of U.S. provisional patent application Ser. No. 60/603,649, filed Aug. 23, 2004, by Douglas Grant Oxborrow and entitled BALLOOMINATOR BALLOON LIGHT.

### BACKGROUND

1. Field of the Invention

This invention relates to a balloon illuminating device, i.e. a balloon illuminator, that is compatible with balloons and specifically lighter than air balloons.

2. Background of the Invention

Previous balloon illumination devices differ from and are inferior to the subject invention in several respects.

Some such efforts place a heat emitting light source, such as a light bulb, inside inflated latex balloons to provide illumination. Examples of such efforts include Akman (U.S. Pat. No. 5,119,281), Neumeier (U.S. Pat. No. 4,794,498) and Marletta (U.S. Pat. No. 4,452,445). Latex balloons might be damaged by the heat generated by such a light source. A heat emitting light source facilitates the escape of gas from a lighter than air balloon, thus cutting short its effective life. Balloon illumination devices that attach a heat generating light source to the outer surface of a balloon, such as Perez (U.S. Pat. No. 5,117,344), suffer from the same disadvantages.

Previous balloon illumination devices often call for the light source placed inside the balloon to be connected via a cord, electrical or otherwise, to a power source located outside the balloon. Such devices (e.g. Zingale (U.S. Pat. No. 6,106,135), Akman (U.S. Pat. No. 5,119,281), Perez (U.S. Pat. No. 5,075,830), Stewart (U.S. Pat. No. 4,787,575) restrict the movement of the balloon. Often, a balloon employing these devices must be tethered indoors in a location that permits the cord to access an external power source. The inability to carry balloons outdoors or freely indoors, of course, severely restricts their utility.

Efforts to employ apparatus to light balloons frequently use mechanisms for keeping open the neck of a balloon so that a light source may be guided through the opening created by the mechanism (e.g. Schalk (U.S. Pat. No. 5,295,891), Akman (U.S. Pat. No. 5,119,281), Malcolm (U.S. Pat. No. 5,083,250)). Though they may differ, such means for creating apertures imply a relatively complex method for illuminating the balloon and a cumbersome and not self-contained apparatus, with the light source, power source and means for creating a sufficient sized aperture in the neck of the balloon separated.

This invention—in its various embodiments—differs from prior attempts to create balloon illumination devices in several respects, including the aforementioned ways, as should become evident during examination.

### SUMMARY OF THE INVENTION

The subject invention relates to a novel device for use in illuminating the interior of a balloon. More particularly, this novel balloon illuminator includes a light emitting diode (or L.E.D.), which does not emit heat, a direct current power source (such as one or more batteries), means to switch the light emitted from a constant light to a flashing light, all contained in a housing sized to fit easily within the neck of a party balloon, with the inner lining of said housing made of electricity conducting material so that when fully assembled the different components, together with the housing, complete an electrical circuit. The components of the balloon illuminator are sized so that, when affixed to a standard sized party balloon (a ten inch balloon), the balloon even with the balloon illuminator attached retains enough lifting power when filled with lighter than air gas to remain afloat. In the preferred embodiment, a lens is included in the balloon illuminator and placed in contact with the light emitting end of the L.E.D with said lens shaped to disperse the light emitting from the L.E.D.

In the preferred embodiment, a user can switch the balloon illuminator from blinking light mode to constant light mode by changing the polarity of the batteries. The mechanism for changing modes can be enabled by using diodes positioned to route the current through a capacitor (thus generating a flashing light) with the battery oriented in one polarity and that route the current to avoid the capacitor with the battery oriented in a different polarity (thus generating a constant light). The diodes effectively create a virtual switch in the circuitry that routes current through either one of two different pathways. In the preferred embodiment, the logic set forth in the circuitry is embodied in an integrated circuit that is incorporated into the L.E.D.

Different monochromatic L.E.D.s can be used in connection with the invention. Each one gives off a different color, which depending on the mode, can be either constant or flashing.

In one variant, a multi-color L.E.D., rather than a monochromatic L.E.D., is used to permit the balloon illuminator, once fully assembled, to cycle automatically through a series of colors.

In the preferred embodiment, the balloon illuminator may be placed inside the neck of a balloon above the knot used to seal in the gases. The balloon illuminator in this embodiment would be oriented with the light from the L.E.D., which passes through the lens in a preferred embodiment, directed upward. A rubber O-ring or other ligature means can be used to fix the balloon illuminator in the neck of the balloon. Alternatively, the balloon illuminator may be placed inside the balloon without being tied to any part of the balloon. Once the neck has been sealed, the balloon illuminator would then be free to move inside the now enclosed balloon.

The balloon illuminator, once fully assembled with the circuit closed, is impermeable to liquids. Liquid sealants are available for use in coating the inside of a latex balloon in order to slow the leakage of gases through the latex membrane. Because it is impermeable to liquids in its operational state with the electrical circuit closed and the L.E.D. emitting a light, the balloon illuminator is fully compatible with such liquid sealants.

### BRIEF DESCRIPTION OF THE DRAWINGS

The objects, advantages and features of the invention will become more apparent by reference to the drawings, which are appended hereto and made a part hereof.

FIG. 1 shows a fully assembled balloon illuminator affixed to the interior of the neck of a balloon by an O-ring.

FIG. 2 shows an exploded view of the balloon illuminator.

FIG. 3 illustrates the passage of light through the lens of the balloon illuminator and the dispersal of said light by said lens.

FIG. 4 is a circuit diagram illustrating the logic of the electrical circuit formed by a fully assembled balloon illuminator when the balloon illuminator is giving off a constant light.

FIG. 5 is a circuit diagram illustrating the logic of the electrical circuit formed by a fully assembled balloon illuminator when the balloon illuminator is giving off a flashing light.

FIG. 6 shows the logic of a circuit diagram that permits a balloon illuminator to operate either in a constant light mode or a flashing light mode.

FIG. 7 shows the path taken by electrical current when the balloon illuminator is operating in constant light mode.

FIG. 8 shows the path taken by electrical current when the balloon illuminator is operating in flashing light mode.

### DESCRIPTION OF THE PREFERRED EMBODIMENT

A preferred embodiment of the balloon illuminator is a L.E.D. or light emitting diode included in an electrical circuit that causes the L.E.D. to flash when the battery, i.e. direct current power source, is oriented one way and that causes the L.E.D. to emit a constant light when the polarity of the direct current power source is reversed. All of the components of the balloon illuminator are included in a single housing that is sized to fit easily into or through the neck of a party balloon where the balloon illuminator may be affixed by an O-ring or other ligature means. The weight and size of the balloon illuminator are such that a standard ten inch party balloon with a balloon illuminator affixed may remain afloat if filled with lighter than air gas.

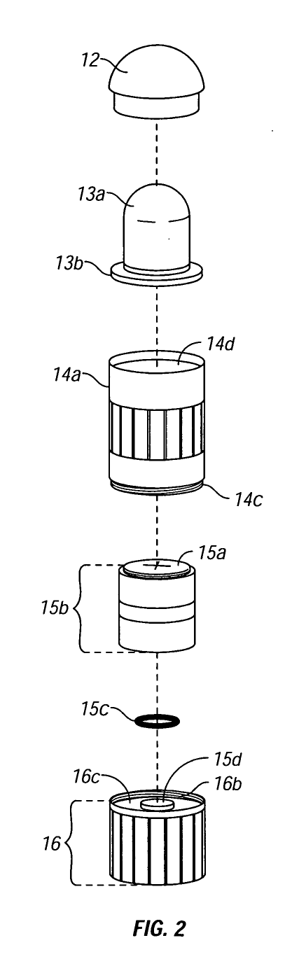

In its preferred embodiment, a balloon illuminator includes, as shown in FIG. 2, a lens 12, a light emitting diode 13a, an integrated circuit forming the base of the light emitting diode 13b, the top half of a housing 14a, a battery or series of batteries 15b that can be slidably placed inside the body of the housing 14a either with the positive end 15a or the opposite negative end touching the integrated circuit base 13b of the light emitting diode 13a. The end of the battery facing away from the L.E.D. engages a contact point 15d on the bottom portion of the housing 16, with said contact point circumscribed by a rubber O-ring 15c.

In a fully assembled balloon illuminator, as illustrated in FIG. 9, only the lens 12 and the top 14a and bottom 16 halves of the housing would be visible. The remainder of the components would be hidden from view inside the housing. As shown in FIG. 2, the matching threads in the top 14c and bottom 16b parts of the housing permit the battery 15b, the inner surface of the housing for the top 14d and bottom 16c halves of the housing to make firm contact. Together with the L.E.D. 13a, the integrated circuit 13b and the battery 15b, the inner lining of the housing 14d, which is made of electricity conducting material, creates a completed circuit once the balloon illuminator has been fully assembled and the top 14a and bottom 16 halves of the housing have been engaged using the matching threads on the bottom of the top half of the housing 14c and those threads found on the top of the bottom housing 16b.

Such a balloon illuminator need not have a lens to be operational. Though not a preferred embodiment, the balloon illuminator can be used with a naked L.E.D. Alternatively, any translucent means that permit the light emitted by the L.E.D. to pass through can be used in place of the lens.

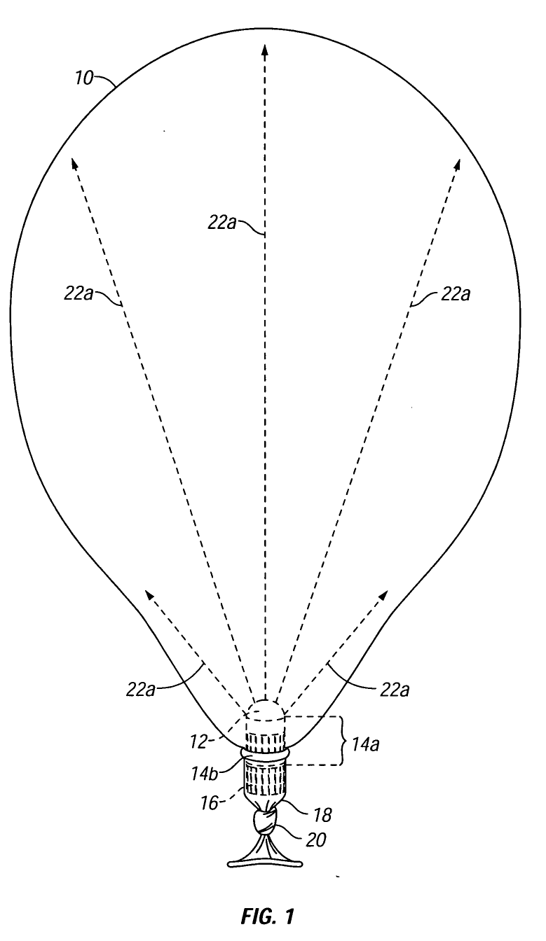

The balloon illuminator, in its preferred embodiment, is placed within the neck 18 of a balloon 10, as illustrated in FIG. 1, with the light emitting end, in the preferred embodiment a lens 12, pointed toward the top of the balloon. When fully assembled and emitting light, the balloon illuminator's lens 12, housing top 14a and housing bottom 16 would be visible. A rubber O-ring 14b in the preferred embodiment would be used to hold the balloon illuminator in place in the neck of the balloon. The balloon would be sealed using a knot 20 or other ligature means. Light from the L.E.D. 22a that passes through the lens would be dispersed inside the body of the balloon.

A fully assembled balloon illuminator may also be placed inside the body of a balloon without being tethered in place by an O-ring or other ligature means. Once sealed inside the balloon by a knot or other means for closing the end of a balloon, such a balloon illuminator could move freely inside the sealed body of the balloon.

Because it is impermeable to liquid, a fully assembled balloon illuminator may be placed inside the body of an inflated balloon that has been treated with liquid sealant designed to minimize the seapage of gas through the latex membrane.

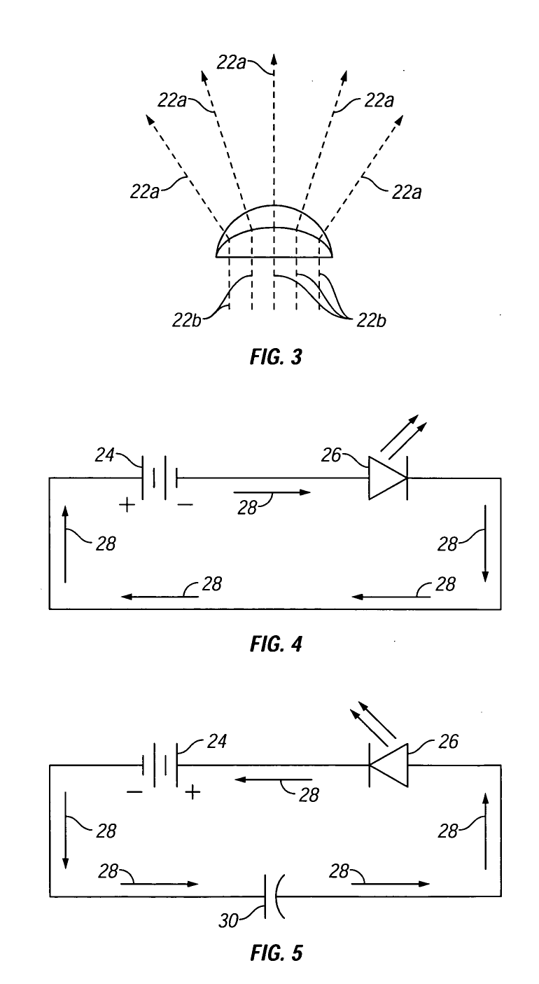

FIG. 3 illustrates how light from the L.E.D. 22b is dispersed 22a by a balloon illuminator lens so that the light would better illuminate the interior of the balloon.

As illustrated in FIG. 4, a L.E.D. 26 placed in a circuit with a battery or batteries 24 would emit a constant light as the current 28 from the battery passes through the L.E.D. Monochromatic L.E.D.s placed in such a circuit would give off a constant light of a given color. The direction of the current flow is given by the arrows 28 depicted in FIG. 4.

In a different embodiment, the L.E.D. 26 in FIG. 4 could be a multi colored L.E.D. instead of a monochromatic L.E.D. A multi colored L.E.D. in the circuit illustrated in FIG. 4 would cycle through the series of colors that the L.E.D. is designed to emit, which colors may vary depending on the type of multi-colored L.E.D. used. The direction of the current flow would remain that given by the arrows 28 depicted in FIG. 4.

As illustrated in FIG. 5, a L.E.D. 26 placed in a circuit with a battery or batteries 24 and a capacitor 30 will give off a flashing light as the capacitor intermittently charges up and then discharges electrical current 28. As the capacitor charges up, the current flow to the L.E.D. stops, causing the L.E.D. to stop emitting light. As the capacitor discharges stored current, the current flow to the L.E.D. resumes, causing the L.E.D. to emit light. Monochromatic L.E.D.s placed in such a circuit would give off a flashing light of the L.E.D.'s given color. The direction of the current flow is given by the arrows 28 depicted in FIG. 5.

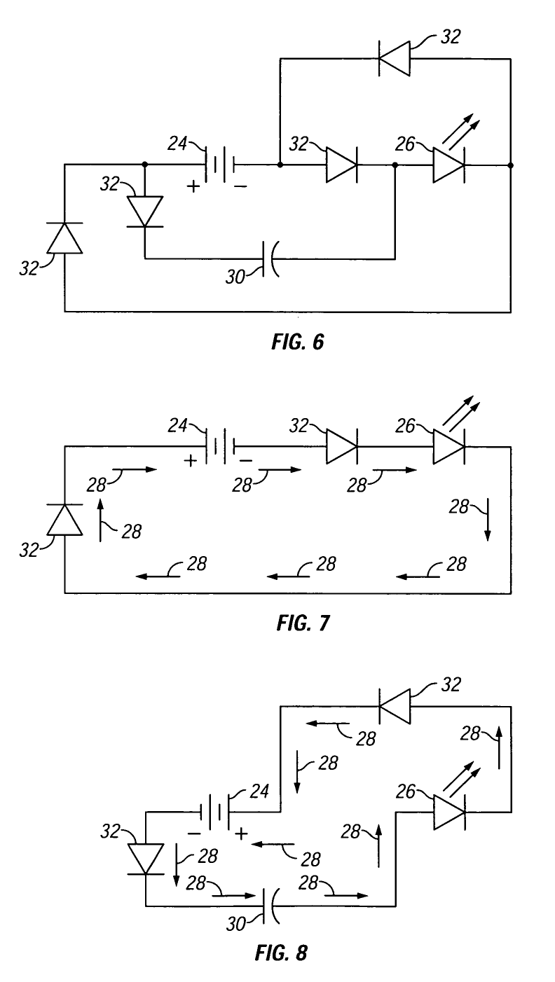

The balloon illuminator combines the logic of the circuitry illustrated in FIG. 4 and FIG. 5 into a single circuit as illustrated in FIG. 6. The balloon illuminator's electrical circuitry, as illustrated in FIG. 6, permits electrical current to travel two alternative pathways—one that causes the L.E.D. to emit a blinking light and one that causes the L.E.D. to emit a constant light. FIG. 6 models the logic using diodes 32, a capacitor 30, a direct current power source, such as a battery or batteries 24, and a light emitting diode 26. In the preferred embodiment, the logic of the circuit would be imbedded in an integrated circuit. However, the use of an integrated circuit is not necessary to practice this invention.

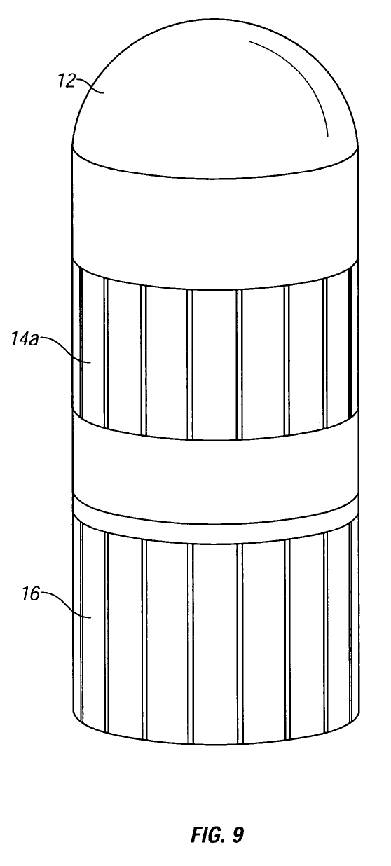

FIG. 7 models one of the two available pathways depicted in FIG. 6. When the battery, FIG. 2-15b, is placed inside the housing, FIG. 2-14a, of the balloon illuminator with one polarity, the current, FIG. 7-28, does not flow through the capacitor, as illustrated in FIG. 7, and the L.E.D. emits a constant light. When the battery polarity is such that the L.E.D. emits a constant light, the current travels along the alternative pathway depicted in FIG. 7 to the exclusion of the alternative pathway depicted in FIG. 8. FIG. 7 models this pathway with depictions of a battery 24, diodes 32, L.E.D. 26 and current flow 28.

FIG. 8 illustrates the alternative pathway that electrical current may take in the bimodal electrical circuit illustrated in FIG. 6. When the polarity of the battery, FIG. 2-15b, FIG. 8-24, is reversed inside the housing of the balloon illuminator, FIG. 2-14a, the current, FIG. 8-28, must take the pathway that contains a capacitor 30. When the capacitor 30 is charging up, the current flow to the L.E.D. 26 stops causing the L.E.D. 26 momentarily to stop emitting light. Once the capacitor 30 stores enough electrical charge to exceed its capacity, the capacitor 30 discharges causing current 28 to flow to the L.E.D. 26, which then emits light. As the capacitor alternatively charges and discharges, the L.E.D. intermittently emits light. The pathway that the current 28 takes when the polarity of the battery causes the L.E.D. to emit a flashing light is modeled in FIG. 8, with the battery 24, diodes 32, L.E.D. 26, current flow 28 and capacitor 30 reproduced.

The circuits illustrated in FIGS. 6, 7 and 8 are closed, the current flows and the balloon illuminator emits light when, as illustrated in FIG. 2, the battery 15b is inserted into a preassembled housing 14a that includes a lens 12, a L.E.D. 13a, and an integrated circuit 13b. The bottom end of the battery is enclosed by the bottom half of the housing 16 with the bottom end of the battery making contact with a metal contact 15d and a rubber O-ring 15c. The top part of the housing 14a and the bottom part 16 are engaged and tightened using the matching threads 14c, 16b contained on each half. Because the lining, 14d & 16c, of the housing is made of electricity conducting material, inserting the battery into the housing, preassembled with lens, L.E.D. and integrated circuit, and snugly engaging and tightening the matching threads on the two halves of the housing creates a closed electrical circuit.

While the discussion has emphasized latex balloons, the balloon illuminator may be used with balloons of any material.

The scope of the invention is not to be limited by the examples set forth but only by the appended claims and their legal equivalents.

What is claimed is:

1. A balloon illumination device comprising
a light emitting diode component,
a battery component,
component means to cause the light emitting diode to emit either a constant light or a flashing light depending on the polarity of the battery,
housing with an inner lining of electricity conducting material with said housing sized to contain said components of said balloon illumination device wherein said components when assembled inside said housing complete an electrical circuit.

2. The balloon illumination device of claim 1 further comprising a lens.

3. The balloon illumination device of claim 2 wherein said device is sized to permit a standard sized party balloon filled with lighter than air gas to remain afloat even with said device affixed to said balloon.

4. The balloon illumination device of claim 3 wherein the device when fully assembled is impermeable to liquid.

5. The balloon illumination device of claim 4 wherein said component means to cause the light emitting diode to emit either a constant light or a flashing light depending on the polarity of the battery is comprised of a capacitor and four diodes arranged to form a completed electrical circuit with said light emitting diode component and said battery component with said completed electrical circuit requiring current flow through the capacitor when the battery has a given polarity and requiring current flow to avoid the capacitor when the battery has the opposite polarity.

6. The balloon illumination device of claim 4 wherein said component means to cause the light emitting diode to emit either a constant light or a flashing light depending on the polarity of the battery is comprised of an integrated circuit that incorporates the logic of an electrical circuit comprising a battery, a capacitor, a light emitting diode, and four diodes arranged to require current flow through the capacitor when the battery has a given polarity and to require current flow to avoid the capacitor when the battery has the opposite polarity.

7. A balloon illumination device comprising
a multi-color light emitting diode component,
a battery component,
housing with an inner lining of electricity conducting material with said housing sized to contain said components of said balloon illumination device wherein said components when assembled inside said housing complete an electrical circuit.

8. The balloon illumination device of claim 7 further comprising a lens.

9. The balloon illumination device of claim 8 wherein said device is sized to permit a standard sized party balloon filled with lighter than air gas to remain afloat even with said device affixed to said balloon.

10. The balloon illumination device of claim 9 wherein the device when fully assembled is impermeable to liquid.

11. A balloon illumination device that can emit either a constant light or a flashing light.

12. A balloon illumination device that can emit light of different colors.
